(19) United States
(12) Patent Application Publication
(10) Pub. No.: US 2018/0308138 A1
(43) Pub. Date: Oct. 25, 2018

(54) DATA PROCESSING METHOD AND APPARATUS

(71) Applicant: Nanjin Tangyi Digital Technology CO., Ltd, Nanjing City (CN)

(72) Inventor: Yi TANG, Nanjing (CN)

(21) Appl. No.: 15/522,293

(22) PCT Filed: Apr. 27, 2016
(86) PCT No.: PCT/CN2016/080370

§ 371 Date: Dec. 28, 2017

(30) Foreign Application Priority Data
Nov. 17, 2015 (CN) CN201510789563.8

(51) Int. Cl. G06Q 30/06; H04L 29/08

(52) U.S. Cl. CPC G06Q 30/0607; G06Q 30/0613; H04L 67/306

(57) ABSTRACT

Provided are a method and apparatus for processing a purchase request. The method comprises: receiving and storing a purchase request sent by a user terminal, wherein the purchase request comprises a user account; judging whether the purchase request is a first order corresponding to the user account; and if so, allocating, according to a first preset rule, resources to an account matching the user account according to a first preset relationship; otherwise, allocating, according to a second preset rule, resources to an account matching the user account according to a second preset relationship. Compared with the prior art, the resource allocation mechanism of the present invention can be beneficial to the promotion of products and the expansion of sales channels.

### CROSS REFERENCES TO RELATED ART

This application claims priorities to a Chinese patent application with application number of 201610240012.0, submitted to Chinese patent office on Apr. 18, 2016 and titled “purchase request method and apparatus” and to a Chinese patent application with application number of 201610729813.3, submitted to Chinese patent office on Aug. 25, 2016 and titled “data processing method and apparatus”, disclosures of which are incorporated herein by reference in their entireties.

### FIELD OF THE INVENTION

The application relates to the technical field of computer data processing, and more specifically, to a data processing method and apparatus.

### BACKGROUND OF THE INVENTION

In the prior art, a user often can directly join a system or purchase from the system by accessing a webpage of the system. However, the existing access mode and purchase mode are not beneficial to user management and commodity promotion in setting.

### SUMMARY OF THE INVENTION

Embodiments of the application provide a data processing method and apparatus.

The data processing method provided by embodiments of the application comprises:

receiving a joining request of a user, wherein the joining request comprises a temporary account of the user and a system account of a recommender;

acquiring a region of the user according to the temporary account of the user;

judging whether the region of the user is identical with a region of the recommender;

if so, generating a system account for the user according to a preset rule and storing the system account of the user; and

if not, prompting that the user fails to join the system.

Another data processing method provided by embodiments of the application comprises:

receiving and storing a purchase request of the user, wherein the purchase request comprises a system account;

judging whether the purchase request also comprises a temporary account;

generating the system account for the temporary account and distributing resources for an account having a first preset relationship with the generated system account according to the first preset rule when the purchase request also comprises the temporary account; and

distributing resources for an account having a second preset relationship with the system account in the purchase request according to a second preset rule when the purchase request does not comprise the temporary account.

A data processing apparatus provided by embodiments of the application comprises: a processor and a storage medium in which computer executable instructions are stored; and when the processor executes the computer executable instructions, the processor executes the following steps:

receiving a joining request of a user, wherein the joining request comprises a temporary account of the user and a system account of a recommender;

acquiring a region of the user according to the temporary account of the user;

judging whether the region of the user is identical with a region of the recommender;

if so, generating a system account for the user according to a preset rule and storing the system account of the user; and

if not, prompting that the user fails to join the system.

Another data processing apparatus provided by embodiments of the application comprises: a processor and a storage medium in which computer executable instructions are stored; and when the processor executes the computer executable instructions, the processor executes the following steps:

receiving and storing a purchase request of the user, wherein the purchase request comprises a system account;

judging whether the purchase request also comprises a temporary account;

generating the system account for the temporary account and distributing resources for an account having a first preset relationship with the generated system account according to the first preset rule when the purchase request also comprises the temporary account; and

distributing resources for an account having a second preset relationship with the system account in the purchase request according to a second preset rule when the purchase request does not comprise the temporary account.

### BRIEF DESCRIPTION OF THE DRAWINGS

FIG. 1 is a schematic diagram of interaction between a server and a user terminal provided in embodiments of the application;

FIG. 2 is a block schematic diagram of a server provided in embodiments of the application;

FIG. 3 is a flow chart of a data processing method provided in embodiments of the application;

FIG. 4 is a flow chart of a preset rule in a data processing method provided in embodiments of the application;

FIG. 5 is a flow chart of step S360 in a data processing method provided in embodiments of the application;

FIG. 6 is a flow chart of step S370 in a data processing method provided in embodiments of the application;

FIG. 7 is a schematic diagram of a functional module of a data processing apparatus provided in embodiments of the application;

FIG. 8 is a flow chart of another data processing method provided in embodiments of the application;

FIG. 9 is a flow chart of another data processing method provided in embodiments of the application;

FIG. 10 is a flow chart of another data processing method provided in embodiments of the application; and

FIG. 11 is a schematic diagram of a functional module of another data processing apparatus provided in embodiments of the application.

### DETAILED INVENTION OF THE INVENTION

To enable those skilled in the art to better understand the solutions of the present invention, technical solutions in the embodiments of the application will be clearly and completely described below in combination with drawings in the embodiments of the application. Apparently, the described embodiments are only part of embodiments of the application, not all of the embodiments. The following detailed description of the embodiments of the application provided in the drawings are not intended to limit the scope of the claimed application, but to indicate selected embodiments of the application only. Based on the embodiments in the application, all other embodiments obtained on the premise of not making creative labor by those ordinary skilled in the art shall fall into the scope of the present application.

Similar labels and letters indicate similar items in the drawings below. Therefore, once an item is defined in one drawing, the item does not need to be further defined and explained in subsequent drawings. In addition, in the description of the application, terms such as “first” and “second”, etc. are used for distinguishing description only, and shall not be interpreted to indicate or imply relative importance or time order.

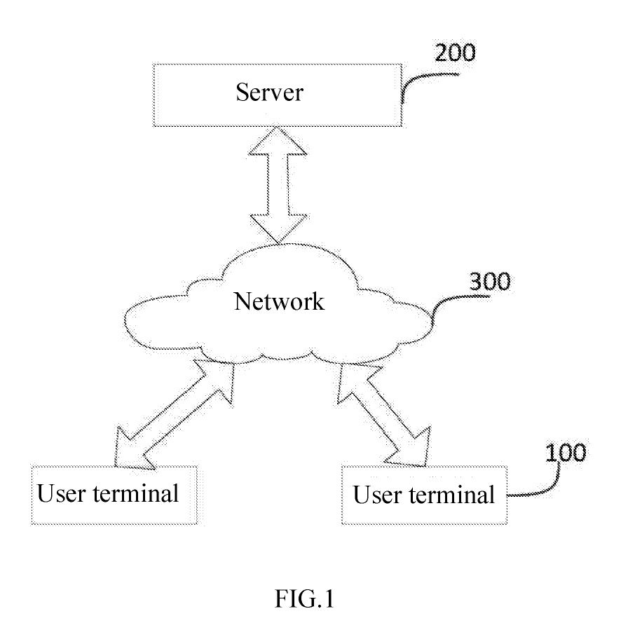

As shown in FIG. 1, the drawing is a schematic diagram of interaction between a server 200 and a user terminal 100 provided in embodiments of the application. Server 200 performs data communication with one or more user terminals 100 through a network 300, so as to perform data communication or interaction. Server 200 may be a distributed file storage server, a network server, a database server side, etc. User terminal 100 may be a Personal Computer (PC), a tablet computer, a smart phone, etc.

In the embodiments of the application, a client is installed in the user terminal 100, and may be a browser or third-party application software which corresponds to the server 200 for providing the user with local services, such as registration, login, page browsing, etc.

Server 200 in the embodiment may be a single server or a server cluster, and may comprise many servers such as a WEB server, a search server, a computation server, etc.

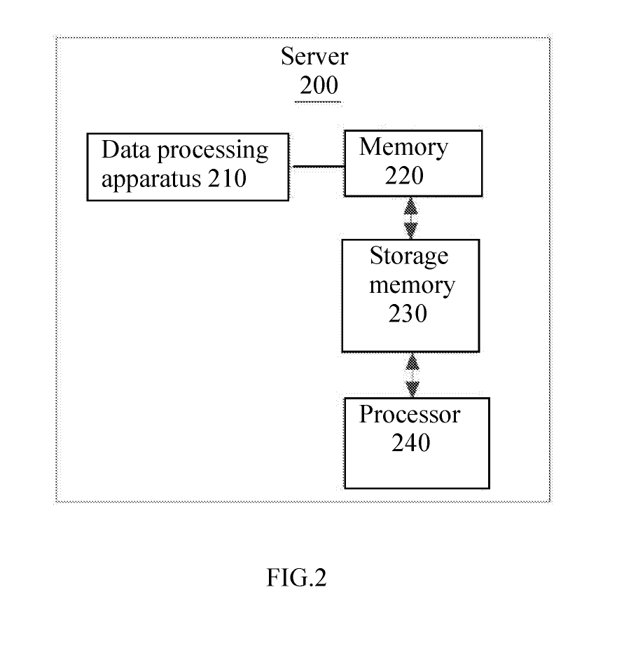

As shown in FIG. 2, the drawing is a block schematic diagram of the server 200. Server 200 may comprise a data processing apparatus 210, a memory 220, a storage controller 230 and a processor 240.

Elements of the server 200, the storage controller 230 and the processor 240 are electrically connected directly or indirectly, so as to realize data transmission or interaction. For example, the elements can realize electrical connection through one or more communication buses or signal lines. The data processing apparatus 210 may comprise at least one software functional module stored in the memory 220 in a software or firmware form or solidified in an Operating System (OS) of the server 200. The processor 240 is used for executing an executable module stored in the memory 220, such as a software functional module or a computer program included in the data processing apparatus 210.

Wherein the memory 220 may be, but not limited to, a Random Access Memory (RAM), a Read Only Memory (ROM), a Programmable Read-Only Memory (PROM), an Erasable Programmable Read-Only Memory (EPROM), an Electric Erasable Programmable Read-Only Memory (EEPROM), etc., wherein the memory 220 is used for storing the program, and after receiving an executing instruction, the processor 240 executes the program. The method executed by the server side defined in the process revealed in previous any embodiment of the application can be applied to the processor or realized by the processor.

The processor 240 may be an integrated circuit chip having signal processing capability. The above processor may be a general-purpose processor, including a Central Processing Unit (CPU), a Network Processor (NP), etc.; and may also be a Digital Signal Processor (DSP), an Application Specific Integrated Circuit (ASIC), a Field-Programmable Gate Array (FPGA) or other programmable logic devices, discrete devices or transistor logic devices, and discrete hardware components. All methods, steps and logic block diagrams disclosed in the embodiments of the application can be realized or executed. The general-purpose processor may be a microprocessor or the processor may be any conventional processor, etc.

It can be understood that the structure shown in FIG. 2 is only schematic, and the server 200 may also comprise more or less components than those shown in FIG. 2, or may have configurations different from those shown in FIG. 2. All the components shown in FIG. 2 can be realized by hardware, software or a combination of them.

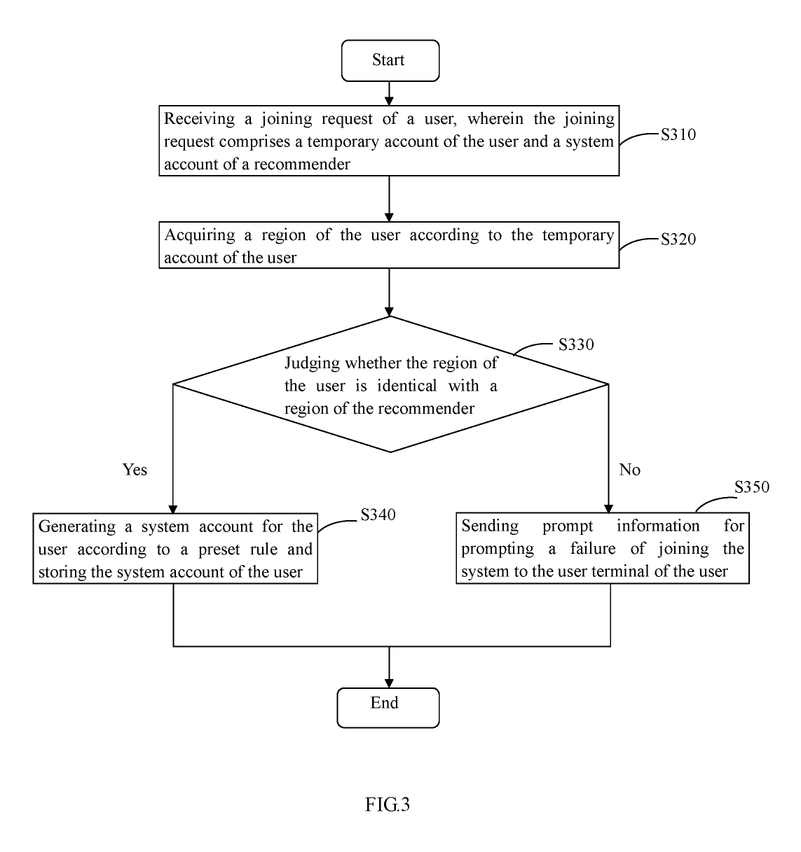

FIG. 3 shows a flow chart of the data processing method provided in embodiments of the application. With reference to FIG. 3, the method described in the embodiments is executed by the server, and comprises step S310 to step S350.

In the step S310, the joining request of the user is received, and comprises a temporary account of the user and a system account of a recommender,

wherein the temporary account can be obtained by computation according to a user unique identification code and a system unique identification code,

wherein the user unique identification code has many implementation methods which may be a social network account of the user, such as a user Wechat ID, a Wechat two-dimensional code, a user-registered user ID of a system platform, etc. It can be understood that the implementation manners are not limited to the mentioned modes.

Similarly, the system unique identification code has many implementation methods which may be a social network public number of the system, such as a Wechat public number, a Wechat public two-dimensional code; a public ID of a system platform, etc. It can be understood that the implementation manners are not limited to the mentioned modes.

The temporary account of the user can be obtained by computation between the user unique identification code and the system unique identification code. The computation manners are multiple, including addition, multiplication and encryption. It can be understood that the implementation manners are not limited to the mentioned modes.

The system account refers to a unique certification number of the system for the user, which is distributed to the user by the server.

In the step S320, the region of the user is acquired according to the temporary account of the user.

The implementation manners in the step S320 are multiple. For example, if the user unique identification code is the social network account of the user, such as the Wechat number, an interface program is invoked according to an application interface provided to a third party by Wechat, so as to acquire the region of the requesting user to be joined. Of course, it is not limited to this.

In the step S330, the region of the user is judged nether identical with the region of the recommender.

Wherein the region of the recommender can be acquired from the temporary account of the recommender and stored in the server when the recommender passes a region authentication to enter. In judging whether the region of the user is identical with the region of the recommender, the region of the recommender can be acquired from the server and matched with the region of the user. The matching manners are multiple, such as string matching, etc.

The step that the region of the user is judged whether identical with the region of the recommender can be determined according to the geographical positions of the user and the recommender, wherein the size of the region involved in the application can be determined according to actual conditions, and is not limited in the embodiment of the application. For example, the user and the recommender in Jiangsu province can be regarded to belong to the same region, and the user and the recommender in China can also be regarded to belong to the same region. In addition, the user and the recommender which are respectively in China and Japan can also be regarded to belong to the same region.

If the region of the user is identical with the region of the recommender, the step S340 is executed; otherwise, the step S350 is executed.

In the step S340, the system account is generated for the user according to the preset rule, and the system account of the user is stored.

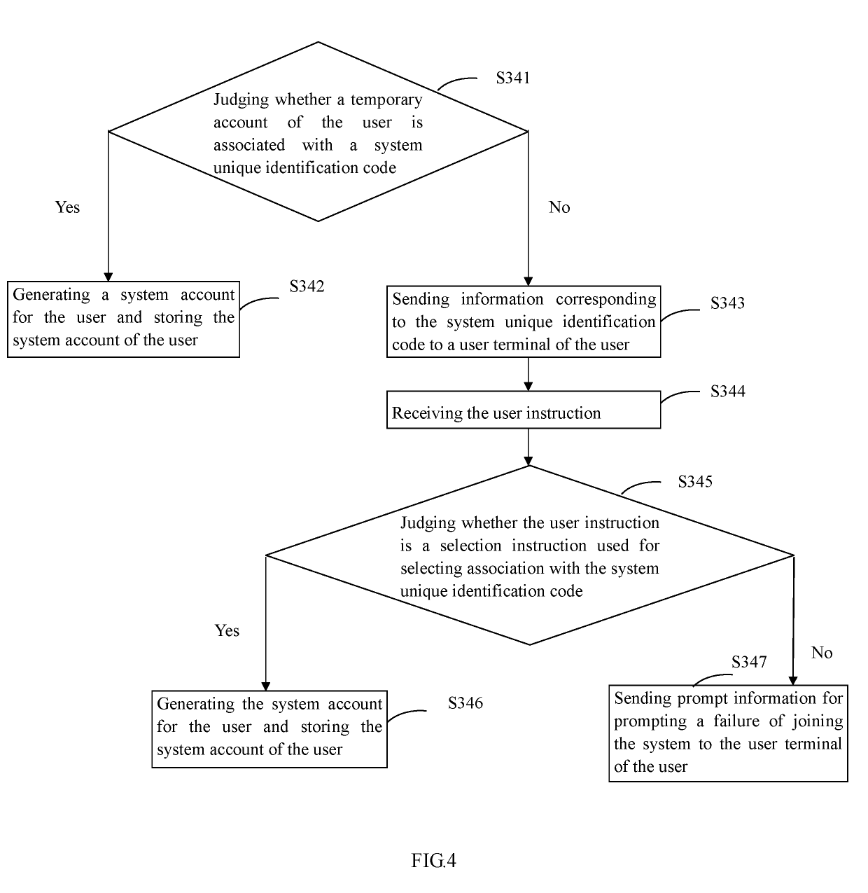

As an implementation manner, with reference to FIG. 4, the step S340 may comprise step S341 to step S347.

In the step S341, the temporary account of the user is judged whether associated with the system unique identification code.

If the temporary account of the user is associated with the system unique identification code, the step S342 is executed; otherwise, the step S343 is executed.

In the step S342, the system account is generated for the user, and the system account of the user is stored.

At this moment, the user joins the system and becomes a system user.

In the step S343, information corresponding to the system unique identification code is sent to a user terminal of the user.

If the user unique identification code is the social network account of the user, such as the Wechat number, then the server returns the system unique identification code, i.e., a subscribed interface of the Wechat public number, to the user terminal of the user.

In the step S344, the user instruction is received.

In the step S345, the user instruction is judged whether to be a selection instruction used for selecting association with the system unique identification code.

If the user instruction is used for selecting association with the system unique identification code, the step S346 is executed; otherwise, the step S347 is executed.

In the step S346, the system account is generated for the user, and the system account of the user is stored.

When the user unique identification code is the user Wechat number, the user subscribes the Wechat public number of the system through the user terminal, i.e., the user instruction is the selection instruction used for selecting association with the system unique identification code. The user joins the system and becomes the system user.

In the step S347, prompt information for prompting a failure of joining the system is sent to the user terminal of the user.

When the user unique identification code is the user Wechat number, the user chooses not to subscribe the Wechat public number of the system through the user terminal; then, the user cannot join the system; the user terminal of the user receives the prompt information for prompting the failure of joining the system, such as “code scanning failed, region mismatched” and other prompt information.

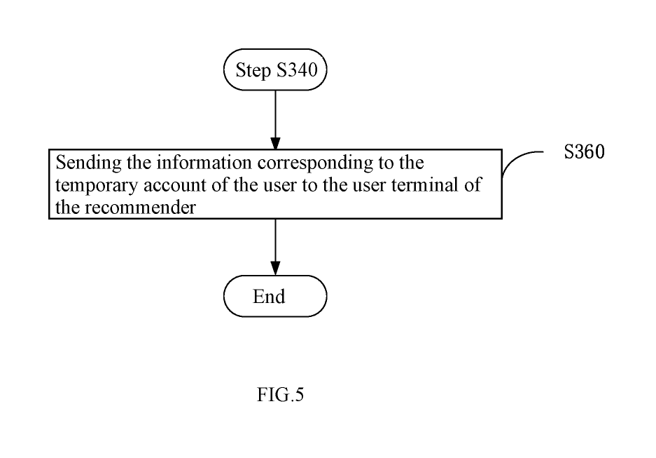

Optionally, with reference to FIG. 5, after the step S340, the method can also include step S360.

In the step S360, the information corresponding to the temporary account of the user is sent to the user terminal of the recommender.

Wherein the information corresponding to the temporary account of the user comprises a social network headshot of the user, a social network account or regional information, etc., so that the recommender can know that the user successfully joins the system by associating the system account of the recommender when receiving the information through the user terminal. For example, the user can associate the system account of the recommender by scanning the Wechat two-dimensional code of the recommender, etc. In subsequent resource allocation, the user is a subordinate user of the recommender, and is favorable for reasonable resource allocation.

In the step S350; the prompt information for prompting a failure of joining the system is sent to the user terminal of the user.

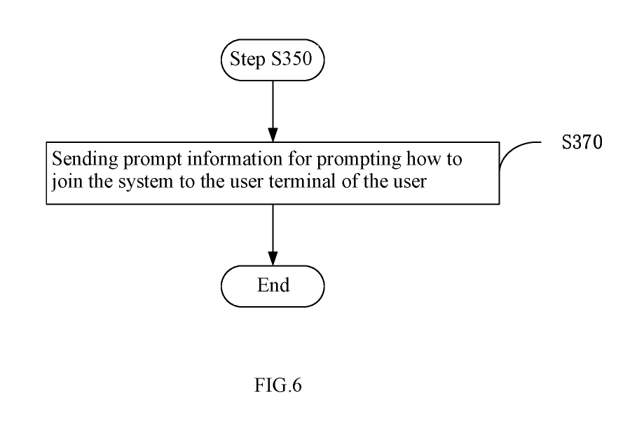

Optionally, with reference to FIG. 6 please, after the step S350, the method can also include step S370.

In the step S370, prompt information for prompting how to join the system is sent to the user terminal of the user.

For example, “scan the two-dimensional code of a recommender in XX city please” or “modify a region in My Wechat-Click the headshot-Region”, etc. can be sent to the user terminal of the user, so that the user can know how to join the system after receiving the prompt information, thereby further increasing the joining proportion of the system user according to the region.

In the data processing method provided in the embodiments of the application, the region of the user is judged whether to be identical with the region of the recommender to determine whether the user is allowed to join the system, i.e., the user is managed according to the region when the user joins the system and only the user within the same region as the recommender can join the system. Such manner can realize the management of the system user according to the region, and can prepare for the resource allocation for subsequent system users according to the region.

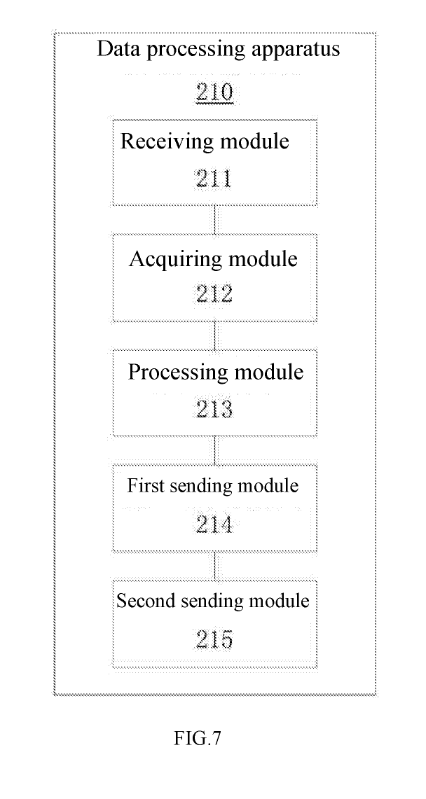

With reference to FIG. 7 please, the drawing is a schematic diagram of a functional module of a data processing apparatus 210 shown in FIG. 2 provided in embodiments of the application. The data processing apparatus 210 is operated in the server 200. The data processing apparatus 210 comprises a receiving module 211, an acquiring module 212 and a processing module 213.

The receiving module 211 is used for receiving the joining request of the user, and the joining request comprises the temporary account of the user and the system account of the recommender.

The acquiring module 212 is used for acquiring the region of the user according to the temporary account of the user.

The processing module 213 is used for judging whether the region of the user is identical with the region of the recommender; if so, generating a system account for the user according to a preset rule and storing the system account of the user; and if not, sending prompt information for prompting a failure of joining the system to the user terminal of the user,

wherein the processing module 213 judges whether the temporary account of the user is associated with the system unique identification code; if so, the processing module 213 generates the system account for the requesting user to be joined, and stores the system account of the user; if not, the processing module 213 sends the information corresponding to the system unique identification code to the user, and receives the user instruction; and if the user instruction is a selection instruction used for selecting association with the system unique identification code, the system account is generated for the user, and the system account of the user is stored.

Optionally, if the user instruction is a selection instruction used for selecting non-association with the system unique identification code, the processing module 213 can also send prompt information for prompting a failure of joining the system to the user terminal of the user.

As an implementation manner, the data processing apparatus can also comprise a first sending module 214 used for sending the information corresponding to the temporary account of the user to the user terminal of the recommender.

As another implementation manner, the data processing apparatus can also comprise a second sending module 215 used for sending prompt information for prompting how to join the system to the user terminal of the user.

All the above modules can be realized by software codes. At this moment, all the above modules can be stored in the memory 220 of the server 200. All the above modules can also be realized by hardware such as the integrated circuit chip.

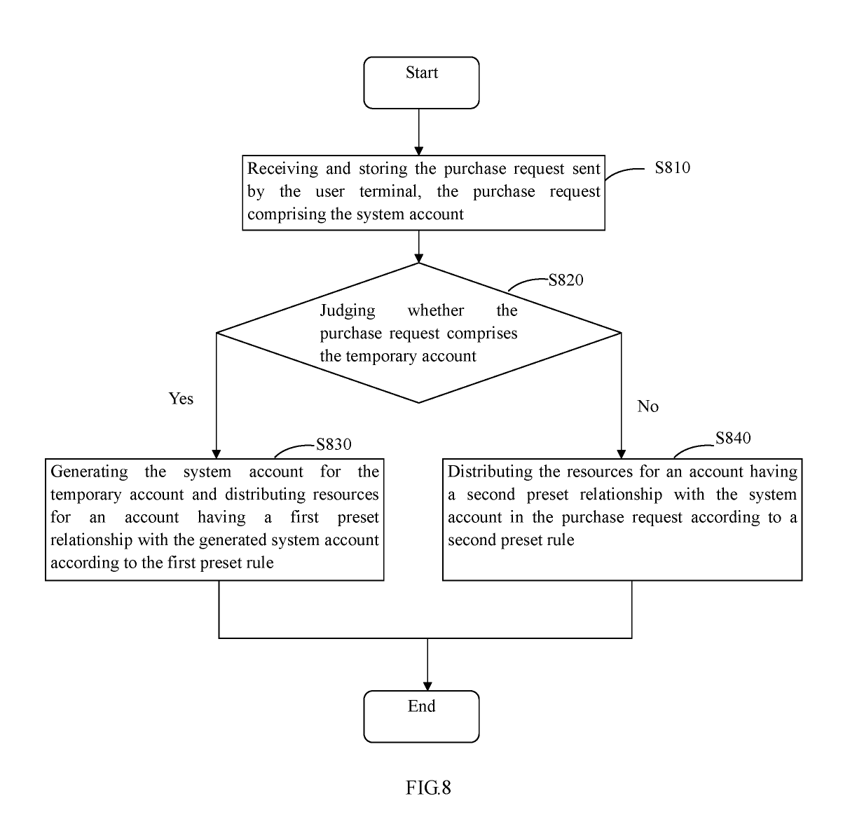

FIG. 8 shows a flow chart of another data processing method provided in embodiments of the application. The method can be applied to environments shown in FIG. 1 and FIG. 2.

In the present embodiment, the client installed on the user terminal 100 can also select commodities to be purchased according to user operation. The client can also comprise a manufacturer client, and an offline manufacturer can enter commodity information, such as commodity description information, commodity pictures, etc., through the manufacturer client. The offline manufacturer can also enter pre-established concrete rules for processing a purchase request through the manufacturer client.

In the present embodiment, the server 200 can comprise a plurality of databases, such as a member database, a commodity database, an order database, etc., wherein the member database can store registration information of the user, etc.; the commodity database can store commodity information and offline manufacturer information related to the commodities, etc.; and the order database can store order information, user information corresponding to the order information, commodity information, related logistics information, etc.

The commodity information in the commodity database can be entered by the offline manufacturer through the manufacturer client, and can be stored in the commodity database by the server 200. The commodity information can comprise commodity pictures, commodity description, etc.

FIG. 1 to FIG. 2 show only examples of an application environment of the embodiments of the application. The concrete implementation manner of the application is not limited to this.

With reference to FIG. 8 please, the method described in the present embodiment is executed by the server, and comprises step S810 to step S840.

In the step S810, the purchase request sent by the user terminal is received and stored, and comprises the system account.

The system account is distributed to the user by the server, and is a unique certification number of the system for the user. It can be understood that the user with the system account is a system user. For example, the user may be a user that has purchased a product from the system, while a temporary user only has the temporary account and has no system account.

Wherein receiving and storing the purchase request sent by the user terminal may include two cases: the first case is: the server receives the purchase request sent by the system user through the user terminal, so the system account included in the purchase request is the system account of the system user in the system; and the other case is: the server receives the purchase request sent by the temporary user through the user terminal, so the system account included in the purchase request is the system account of the recommender. Therefore, the server can judge the purchase request is initiated by the temporary user or the system user by judging whether the purchase request comprises the temporary account.

In the step S820, the purchase request is judged whether to comprise the temporary account,

wherein the temporary account can be obtained by computation according to a user unique identification code and a system unique identification code,

wherein the user unique identification code has many implementation methods which may be a social network account of the user, such as a user Wechat number, a Wechat two-dimensional code, a user-registered user ID of a system platform, etc. It can be understood that the implementation manners are not limited to the mentioned modes.

Similarly, the system unique identification code has many implementation methods which may be a social network public number of the system, such as a Wechat public number, a Wechat public two-dimensional code, a public ID of a system platform, etc. It can be understood that the implementation manners are not limited to the mentioned modes.

The temporary account of the user can be obtained by computation between the user unique identification code and the system unique identification code. The computation manners are multiple, including addition, multiplication and encryption. It can be understood that the implementation manners are not limited to the mentioned modes.

In the step S830, the system account is generated for the temporary account and resources are distributed for an account having a first preset relationship with the generated system account according to the first preset rule when the purchase request also comprises the temporary account,

wherein the resources herein may be monetary amount, or virtual currency or credits, etc.

The first preset rule and the first preset relationship can be a rule or relationship set in advance. For example, the account having the first preset relationship with the generated system account may include N-layer superior accounts of the system account, wherein N is a natural number; and the value of N can be determined according to the actual conditions, and is not limited in the embodiment of the application. For example, when N is equal to 3, the account having the first preset relationship with the generated system account can comprise a first-layer superior account of the system account, a second-layer superior account of the system account, a third-layer superior account of the system account, etc.

When N is equal to 3, the step of distributing the resources for the account having the first preset relationship with the generated system account according to the first preset rule may comprise: transferring a first quantity of resources to the first-layer superior account of the system account; transferring a second quantity of resources to the second-layer superior account of the system account; transferring a third quantity of resources to the third-layer superior account of the system account, etc., wherein a ratio of the first quantity to the second quantity to the third quantity may be determined according to the actual conditions, and is not limited in the embodiment of the application. For example, the third quantity may be greater than the second quantity, the second quantity may be greater than the first quantity, and so on. Optionally, a ratio of the first quantity to the second quantity to the third quantity may be 1:2:3, etc.

In the step S840, the resources are distributed for an account having a second preset relationship with the system account in the purchase request according to a second preset rule when the purchase request does not comprise the temporary account,

wherein the second preset rule and the second preset relationship can be a rule or relationship set in advance. For example, the account having the second preset relationship with the system account in the purchase request may include the account and N-layer superior accounts of the system account, wherein N is a natural number; the value of N can be determined according to the actual conditions, and is not limited in the embodiment of the application. For example, when N is equal to 2, the account having the second preset relationship with the system account in the purchase request may include the system account, a first-layer superior account of the system account, and a second-layer superior account of the system account.

When N is equal to 2, the step of distributing the resources for the account having the second preset relationship with the system account in the purchase request according to the second preset rule may comprise: transferring a fourth quantity of resources to the system account in the purchase request; transferring a fifth quantity of resources to the first-layer superior account of the system account in the purchase request; and transferring a sixth quantity of resources to the second-layer superior account of the system account in the purchase request, wherein a ratio of the fourth quantity to the fifth quantity to the sixth quantity may be determined according to the actual conditions, and is not limited in the embodiment of the application. For example, the fourth quantity may be greater than the fifth quantity, the fifth quantity may be greater than the sixth quantity, and so on. Optionally, a ratio of the fourth quantity to the fifth quantity to the sixth quantity may be 3:2:1, etc.

After receiving the purchase request, the server sends the order information to the client of the offline manufacturer according to the purchase request. The offline manufacturer can arrange delivery according to the order information, and can transfer the delivery-related logistics information to the server through the manufacturer client, and the server can store the logistics information into the order database.

After the server receives the purchase request or the purchase request is finished, the server can send prompt information for prompting, to the user terminal corresponding to the system account included in the purchase request, that the purchase request is finished, etc. For example, the server can send such information as “the purchase succeeds” to the user terminal, wherein the sending time and the sending content of the prompt information may have multiple implementation manners, and are not limited to the described manners.

In the data processing method provided by the embodiments of the application, different preset rules are adopted for distributing the resources by judging whether the purchase request also comprises the temporary account. This distribution manner is bound with an identity of the user, so that a resource distribution mechanism of the application is more favorable for commodity promotion and widening of marketing channels.

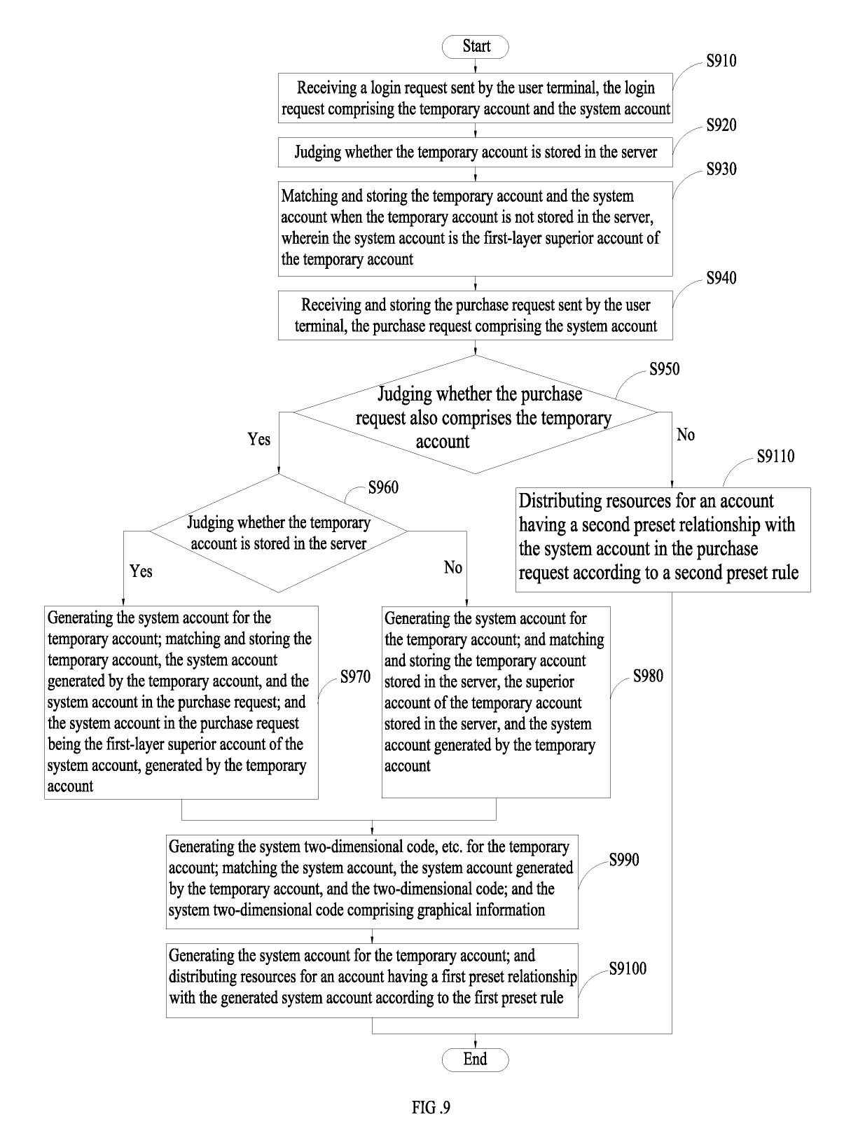

FIG. 9 shows a flow chart of another data processing method provided in embodiments of the application. With reference to FIG. 9 please, the method described in the present embodiment is executed by the server, and comprises step S910 to step S9110.

In the step S910, a login request sent by the user terminal is received, and comprises the temporary account and the system account,

wherein the login request may be initiated to the server in such a manner that the temporary user logs in an own social network account through the user terminal and subscribes the social network public number of the system, for example, after logging in an own Wechat number and subscribing the Wechat public number of the system, the temporary user acquires the temporary account of the temporary user and scans the system two-dimensional code corresponding to the system account of the system user through the user terminal, wherein the implementation manners of initiating the login request may be multiple, and are not limited to this.

In the step S920, the temporary account is judged whether to be stored in the server.

In the step S930, when the temporary account is not stored in the server, the temporary account and the system account are matched and stored and the system account is the first-layer superior account of the temporary account.

If the server judges that the temporary account is stored in the server; the temporary account and the system account included in the login request are not matched and stored. Namely; the server only matches and stores the temporary account and the system account included in the first-initiated login request; when the server receives the login request sent by the user terminal again, when the system account included in the login request is different from the system account included in the first-initiated login request, the server does not match and store the system account included in this login request and the temporary account included in this login request.

In this manner, the server matches and stores the temporary account and the system account included in the first-initiated login request, and ensures that the system account included in the first-initiated login request is always the first-layer superior account of the temporary account. After the purchase request initiated by the user terminal is finished, the server distributes the resources for the superior account of the temporary account according to the preset rule. In this way, rights and interests of the user corresponding to the system account included in the first-initiated login request can be always guaranteed, which is further favorable for commodity promotion and widening of commodity marketing channels.

In the step S940, the purchase request sent by the user terminal is received and stored, and comprises the system account.

Before the server receives and stores the purchase request sent by the user terminal, the method further comprises: receiving an access request, which comprises the temporary account, sent by the user terminal; judging whether the temporary account is stored in the server; and sending information for prompting access failure to the user terminal when the temporary account is not stored in the server.

When temporary account in the access request received by the server is not stored in the server, it indicates that the temporary account does not purchase the product from the system, or the temporary account does not initiate the login request to the server by scanning the system two-dimensional code of the system user. Therefore, the server sends the information for prompting the access failure to the user terminal. The server screens users that enter the system in this manner, and rejects unsatisfactory users, so that the users that can enter the system obtains better services and the user experience is further improved.

In the step S950, the purchase request is judged whether to also comprise the temporary account; step S960 to step S9100 are executed when the purchase request also comprises the temporary account; otherwise, step S9110 is executed.

In the step S960, the temporary account is judged whether to be stored in the server; step S970 is executed when the temporary account is not stored in the server; otherwise, step S980 is executed.

In the step S970, the system account is generated for the temporary account; the temporary account, the system account generated by the temporary account, and the system account in the purchase request are matched and stored; and the system account in the purchase request is the first-layer superior account of the system account, generated by the temporary account.

In the step S980, the system account is generated for the temporary account; and the temporary account stored in the server, the superior account of the temporary account stored in the server, and the system account generated by the temporary account are matched and stored.

In the step S990, the system two-dimensional code, etc. is generated for the temporary account; the system account, the system account generated by the temporary account, and the two-dimensional code are matched; and the system two-dimensional code comprises graphical information,

wherein the system two-dimensional code can also comprise a user headshot, a user name, the temporary account, a user receiving address, a user contact way and other information. Optionally, the graphical information included in the system two-dimensional code is the user headshot information, which is convenient for the server to quickly identify identity information.

In the step S9100, the system account is generated for the temporary account; and resources are distributed for an account having a first preset relationship with the generated system account according to the first preset rule.

When the purchase request does not comprise the temporary account, the step S9110 is executed.

In the step S9110, resources are distributed for an account having a second preset relationship with the system account in the purchase request according to a second preset rule.

It can be understood that step S940, step S950, step S9100 and step S9110 are respectively similar to step S810 to step S840 in the embodiment shown in FIG. 8, and will not be repeated again in the present embodiment.

In the data processing method provided by the embodiments of the application, different preset rules are adopted for distributing the resources by judging whether the purchase request also comprises the temporary account. This distribution manner is bound with an identity of the user, so that a resource distribution mechanism of the application is more favorable for commodity promotion and widening of marketing channels. Moreover, the user experience is further improved by further always binding the superior account and formulating standards for allowing the user to enter the system, which is further favorable for commodity promotion and widening of the marketing channels.

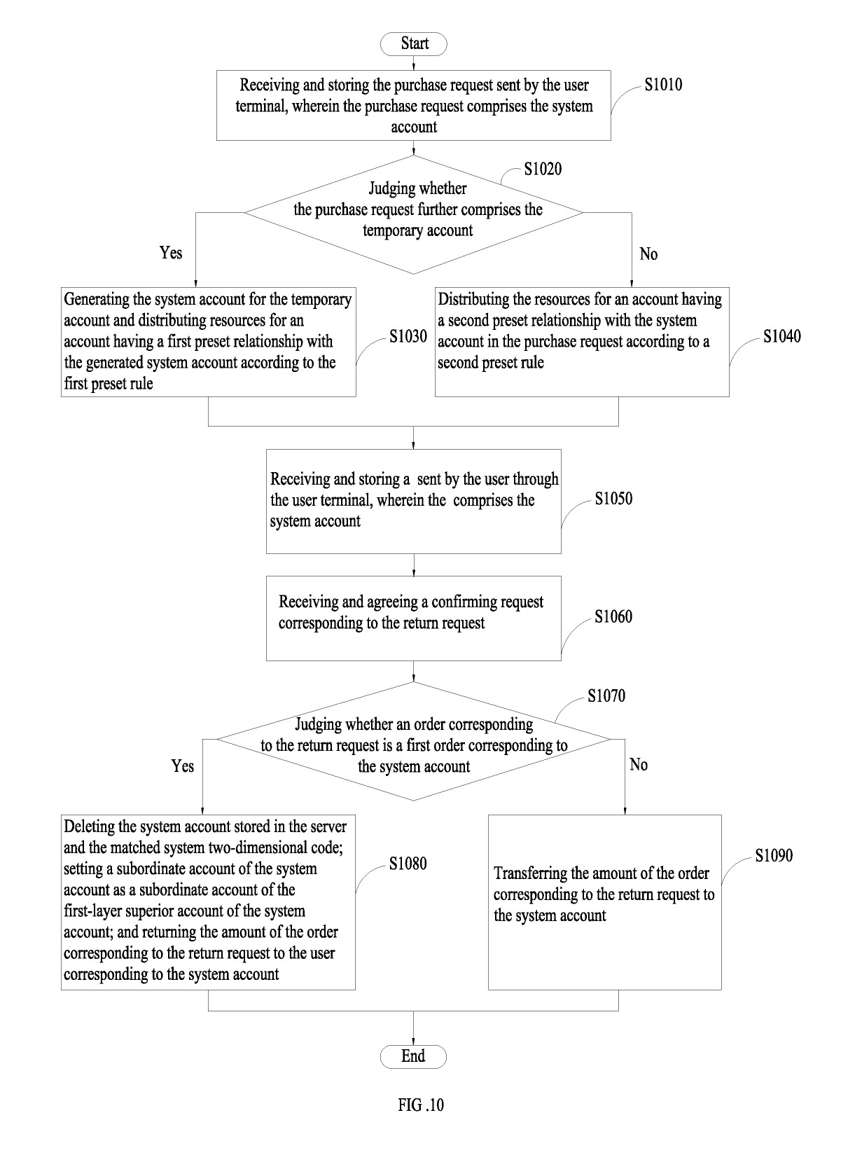

FIG. 10 shows a flow chart of another data processing method provided in the embodiments of the application. With reference to FIG. 10 please, the method described in the present embodiment is executed by the server, and comprises step S1010 to step S1090.

In the step S1010, the purchase request sent by the user terminal is received and stored, and comprises the system account.

In the step S1020, the purchase request is judged whether to further comprise the temporary account.

In the step S1030, the system account is generated for the temporary account and resources are distributed for an account having a first preset relationship with the generated system account according to the first preset rule when the purchase request also comprises the temporary account.

In the step S1040, the resources are distributed for an account having a second preset relationship with the system account in the purchase request according to a second preset rule when the purchase request does not comprise the temporary account,

wherein step S1010 to step S1040 are similar to step S810 to step S840 in the embodiment shown in FIG. 8, and will not be repeated again in the present embodiment.

In the step S1050, a return request sent by the user through the user terminal is received and stored, and comprises the system account.

In the step S1060, a confirming request corresponding to the return request is received and agreed.

After the server receives and agrees the confirming request corresponding to the return request, corresponding return information is stored into the order database of the server.

In the step S1070, an order corresponding to the return request is judged whether to be a first order corresponding to the system account according to the system account.

The server can search the order corresponding to the account from the order database according to the system account included in the return request. If the order corresponding to the account does not exist in the order database, it can be judged that the order corresponding to the return request is the first order corresponding to the account; and if the order corresponding to the system account exists in the order database, it can be judged that the order corresponding to the return request is not the first order corresponding to the system account.

In the step S1080, if the order corresponding to the return request is the first order of the system account, the system account stored in the server and the matched system two-dimensional code are deleted; a subordinate account of the system account is set as a subordinate account of the first-layer superior account of the system account; and the amount of the order corresponding to the return request is returned to the user corresponding to the system account.

In the step S1090, if the order corresponding to the return request is not the first order of the system account, the amount of the order corresponding to the return request is transferred to the system account.

The data processing method can further comprise: receiving and storing a logout request, which comprises the system account, sent by the user through the user terminal; a confirming request is sent to the user terminal; and the user terminal is used for confirming the logout request, and the server deletes the system account and the matched system two-dimensional code.

The server can set two manners for logging out of the system. The first manner is: the user can actively send the logout request to the server through the user terminal; and the other manner is: after sending the purchase request through the user terminal for the first time, the user sends the return request to the server, and at this moment, the server can actively return the amount and disconnect a matching relationship between the system account and other accounts, so as to avoid the profit squeeze behavior of criminals and greatly protect legitimate rights and interests of the user.

In the data processing method provided by the embodiments of the application, different preset rules are adopted for distributing the resources by judging whether the purchase request also comprises the temporary account. This distribution manner is bound with an identity of the user, so that a resource distribution mechanism of the application is more favorable for commodity promotion and widening of marketing channels. Further, the server allows the user to actively log out of the system during use by setting the manner of logging out of the system, or the server allows the unqualified user to actively log out of the system, so as to further improve the user experience for using the system and further facilitate the commodity promotion and the widening of the marketing channels.

The above data processing method can be applied to a distribution system, wherein the superior account may be a superior distribution account and a subordinate account may be a subordinate distribution account.

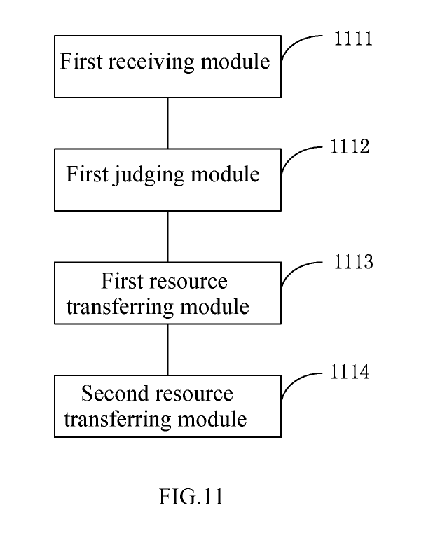

FIG. 11 shows a data processing apparatus provided in embodiments of the application. The apparatus comprises a first receiving module 1111, a first judging module 1112, a first resource transferring module 1113 and a second resource transferring module 1114.

The first receiving module 1111 is used for receiving and storing the purchase request sent through the user terminal, wherein the purchase request comprises a system account.

The first judging module 1112 is used for judging whether the purchase request also comprises a temporary account.

The first resource transferring module 1113 is used for generating the system account for the temporary account and distributing resources for an account having a first preset relationship with the generated system account according to the first preset rule when the purchase request also comprises the temporary account.

The second resource transferring module 1114 is used for distributing resources for an account having a second preset relationship with the system account in the purchase request according to a second preset rule when the purchase request does not comprise the temporary account.

All the above modules can be realized by software codes. At this moment, all the above modules can be stored in the memory 220 of the server 200. All the above modules can also be realized by hardware such as the integrated circuit chip.

It should be noted that various embodiments in the specification are described progressively. The differences of each embodiment from other embodiments are mainly illustrated, and identical and similar parts of vinous embodiments can be referred to each other.

The realization principle and generated technical effects of the data processing apparatus provided by the embodiments of the application are the same as those of the previous method embodiment. For the purpose of brief description, for some contents not mentioned in the apparatus embodiment, refer to corresponding contents in the previous method embodiment.

In several embodiments provided byr the application, it should be understood that the disclosed apparatus and method can also be realized by other manners. The apparatus embodiment described above is only illustrative. For example, flow charts and block diagrams in the drawings show architectures, functions and operation which may be realized by the apparatus, the method and a computer program product according to multiple embodiments of the application. At this point, each box in the flow charts or the block diagrams can represent part of a module, a program segment or codes. The part of the module, the program segment or the codes can include one or more executable instructions used for realizing specified logic functions. It should also be noticed that in some realization manners as substitutes, the functions labeled in the boxes can also occur in a sequence different from that marked in the drawings. For example, two continuous boxes can be almost concurrently executed actually, and sometimes executed in a reverse order, depending on involved functions. It should also be noticed that each box in the block diagrams and/or flow charts, and a combination of the boxes in the block diagrams and/or flow charts can be realized by a special hardware-based system for executing specified functions or actions, or realized by a combination of special hardware and computer instructions.

In addition, each functional module in various embodiments of the application can be integrated together to form an individual part, or each module exists individually, or two or more modules are integrated to form an individual part.

If the functions are realized in the form of a software functional module and is sold or used as an individual product, the functions can be stored in a computer readable storage medium. Based on such understanding, the technical solutions in the application can be reflected in a form of a software product in essence or in a part of making a contribution to the existing art or in a part of the technical solutions. The computer software product is stored in a storage medium, including several instructions to enable one computer device (may be a personal computer, a server side or a network device, etc.) to execute all or some steps of the methods described in various embodiments of the application. The foregoing storage medium includes: various media such as a USB flash disk, a mobile hard disk, a Read-Only Memory (ROM), a Random Access Memory (RAM), a magnetic disc or a compact disc and the like which can store program codes. It should be noted that relationship terms of “first”, “second” and the like in the application are just used for differentiating one entity or operation from the other entity or operation, and do not necessarily require or imply any practical relationship or sequence between the entities or operations. Moreover, terms of “comprise”, “include” or any other variant are intended to cover non-exclusive inclusion, so that a process, a method, an article or a device which includes a series of elements not only includes such elements, but also includes other elements not listed clearly or also includes inherent elements in the process, the method, the article or the device. Under the condition of no more limitation, the elements defined by a sentence “include one . . . ” do not exclude additional identical elements in the process, the method, the article or the device which includes the elements.

The above only describes preferred embodiments of the application and is not intended to limit the application. For those skilled in the art, various variations and changes can be made to the application. Any modification, equivalent replacement, improvement, etc. made within a spirit and a principle of the application shall be contained within the protection scope of the application. It should be noticed that similar labels and letters indicate similar items in the drawings below. Therefore, once an item is defined in one drawing, the item does not need to be further defined and explained in subsequent drawings.

The above only describes concrete embodiments of the application and the protection scope of the application is not limited thereto. Anyone of those skilled in the art familiar with the art can easily think of changes or replacements, which should be covered within the protection scope of the application. Therefore, the protection scope of the application should be determined by the protection scope of the claims.

1. A method for processing a purchase request, comprising:
receiving and storing the purchase request sent by a user terminal, and the purchase request comprises a user account;
judging whether the purchase request is a first order corresponding to the user account;
if yes, allocating resources according to a first preset rule for an account matching the user account according to a first preset relationship;
otherwise, allocating resources according to a second preset rule for an account matching the user account according to a second preset relationship.

2. The method for processing the purchase request according to claim 1, further comprising:
receiving registration information sent by the user terminal;
generating a new user account according to the registration information;
when the registration information comprises identification information of other user accounts, setting the user account corresponding to the identification information as a superior account of the new user account, and setting the new user account as an inferior account of the user account corresponding to the identification information.

3. The method for processing the purchase request according to claim 1, wherein the account matched according to the first preset relationship comprises:
a superior account of the user account in the purchase request;
an account having two-levels superior to the user account comprised in the purchase request; and
an account having three-levels superior to the user account comprised in the purchase request.

4. The method for processing the purchase request according to claim 3, wherein the step of allocating resources according to the first preset rule for the account matching the user account according to the first preset relationship comprises:
transferring a first amount of resources to the superior account of the user account in the purchase request;
transferring a second amount of resources to the account having two-levels superior to the user account in the purchase request; and
transferring a third amount of resources to the account having three-levels superior to the user account in the purchase request.

5. The method for processing the purchase request according to claim 1, wherein the account matched according to the second preset relationship comprises:
a user account in the purchase request;
a superior account of the user account in the purchase request; and
an account having two-levels superior to the user account in the purchase request.

6. The method for processing the purchase request according to claim 5, wherein the step of allocating resources according to the second preset rule for the account matching the user account according to the second preset relationship comprises:
transferring a third amount of resources to the user account in the purchase request;
transferring a second amount of resources to the superior account of the user account in the purchase request; and
transferring a first amount of resources to the account having two-levels superior to the user account in the purchase request.

7. The method according to claim 1, wherein judging whether the purchase request is the first order corresponding to the user account specifically comprises:
judging whether the purchase request further comprises a temporary account;
when the purchase request further comprises the temporary account, the purchase request is the first order; and when the purchase request does not comprise the temporary account, the purchase request is not the first order.

8. The method according to claim 7, wherein when the purchase request further comprises the temporary account, the method further comprises: generating the user account for the temporary account.

9. The method according to claim 8, wherein generating the user account for the temporary account specifically comprises:
judging whether the temporary account is stored in a server;
when the temporary account is not stored in the server, generating the user account for the temporary account; matching and storing the temporary account, the user account generated by the temporary account and the user account in the purchase request, and the user account in the purchase request is a superior account of the user account generated by the temporary account;
when the temporary account is stored in the server, generating the user account for the temporary account; matching and storing the temporary account stored in the server, the superior account of the temporary account stored in the server and the user account generated by the temporary account.

10. The method according to claim 7, wherein before receiving and storing the purchase request sent by the user terminal, the method further comprises:
receiving a login request sent by the user terminal, and the login request comprises the temporary account and the user account;
judging whether the temporary account is stored in the server;
when the temporary account is not stored in the server, matching and storing the temporary account and the user account, and the user account is a superior account of the temporary account.

11. The method according to claim 7, wherein the temporary account is obtained by computation according to a user unique identification code and a system unique identification code.

12. The method according to claim 7, wherein before receiving and storing the purchase request sent by the user terminal, the method further comprises:
receiving an access request sent by the user terminal, and the access request comprises the temporary account;
judging whether the temporary account is stored in a server;
when the temporary account is not stored in the server, sending information for prompting access failure to the user terminal.

13. The method according to claim 1, wherein the account matched with the account according to the first preset relationship comprises:
a superior account of the user account generated by the temporary account;
an account having two-levels superior to the user account generated by the temporary account; and
an account having three-levels superior to the user account generated by the temporary account.

14. The method according to claim 13, wherein the step of allocating resources according to the first preset rule for the account matching the user account according to the first preset relationship comprises:
transferring a first amount of resources to the superior account of the user account user account generated by the temporary account;
transferring a second amount of resources to the account having two-levels superior to the user account generated by the temporary account; and
transferring a third amount of resources to the account having three-levels superior to the user account generated by the temporary account.

15. The method for processing the purchase request according to claim 1, wherein the method further comprises:
generating unique identification information corresponding to the account when the purchase request is the first order corresponding to the user account, an unique identification information corresponding to the account is generated.

16. The method for processing the purchase request according to claim 15, wherein the unique identification information corresponding to the user account is a user two-dimensional code; the user account and the user two-dimensional code is matched; and the user two-dimension code comprises graph information.

17. The method according to claim 15, wherein the method further comprises:
receiving and storing an exit request sent by the user terminal, and the exit request comprises the user account;
sending a confirmation request to the user terminal; and
receiving a request for confirming an exit of the user terminal, and deleting the identification information corresponding to the user account by a server.

18. The method for processing the purchase request according to claim 15, wherein the method further comprises:
receiving and storing a return request sent by the user terminal, and the return request comprises the user account;
receiving a confirmation request corresponding to the return request;
judging whether an order corresponding to the return request is the first order corresponding to the user account according to the user account;
if yes, sending a cancel instruction to the user account to cancel the identification information corresponding to the user account, setting the inferior account of the user account as the inferior account of the superior account of the user account, and transferring the amount of the order corresponding to the return request to the user account;
otherwise, transferring the amount of the order corresponding to the return request to the user account.

19. The method for processing the purchase request according to claim 6, the third amount is larger than the second amount, and the second amount is larger than the first amount.

20. An apparatus for processing a purchase request operated on a server, comprising:
a first receiving module for receiving and storing a purchase request sent by a user terminal, and the purchase request comprises the user account;
a first judging module for judging whether the purchase request is a first order corresponding to the user account;
a first resource transfer module for allocating resources according to a first preset rule for an account matching the user account according to a first preset relationship when the purchase request is the first order corresponding to the user account; and
a second resource transfer module for allocating resources according to a second preset rule for an account matching the user account according to a second preset relationship when the purchase request is not the first order corresponding to the user account.
